(19) United States
(12) Patent Application Publication
(10) Pub. No.: US 2001/0035885 A1
(43) Pub. Date: Nov. 1, 2001

(54) Method of graphically presenting network information

(76) Inventors: Michael Iron, Boston, MA (US); Roi Neustedt, Moshav Netaim (IL); Ohad Ranen, Tel-Aviv (IL)

Correspondence Address: John P. McGonagle, Law Offices of John P. McGonagle, 800 Hingham Street - 2N, Rockland, MA, 02370, US

(21) Appl. No.: 09/812,968

(22) Filed: Mar. 20, 2001

Related U.S. Application Data
(60) Provisional application No. 60/190,108, filed on Mar. 20, 2000.
(60) Provisional application No. 60/198,419, filed on Apr. 19, 2000.

(51) Int. Cl. G06F 3/14; G06F 13/00

(52) U.S. Cl. 345/855; 345/853

(57) ABSTRACT

A graphical gateway to a computer network. The invention method presents network information, i.e., main portals, categories, sub-categories, site search results, site ratings, etc., in a visual way. The method of the present invention presents site locations, according to categories, as a graphical state map. The same map may be topographical symbolizing a rating interest of each site. A network user can quickly locate a desired site through a visual search. Entry into the site may then be made by the user. The map of the invention method provides a user with added information regarding the network, including a site's general content, a site's services, surfing help, etc., all presented in a visual way with the help of map features.

### BACKGROUND OF THE INVENTION

This invention relates to computer networks, and in particular, to a method of presenting and mapping information on the network.

A computer network is a communications network through which a number of computers may interconnect and communicate. The largest and best known computer communications network today is the Internet, a computer communications network based on worldwide data and telephone networks. The Internet is a network of networks, all available for the exchange information. The combination of the Internet with interconnecting computers results in a web, the best known one today commonly referred to as the World Wide Web (“WEB”). The Internet interconnects every computer on the Internet with every other computer on the Internet. The computers connected to a network have various functions and purposes. Some of the interconnected computers are functioning as part of the network itself, i.e., controlling the routing and passage of data to and from various network nodes. Other interconnected computers have files of information that are accessible by other computers connected to the network. Other computers are connected to the network by a user to obtain such files of information. For purposes of the present application each computer with files of information available for access through the network will be referred to as a site. Although the example used in this application is the Internet and World Wide Web, the principles of the present invention are applicable to any computer communications network.

In large networks such as the WEB, the amount of information available is substantial because of the number of sites with available information. In recent years, the growth in number of sites has been exponential and will probably continue to do so for the foreseeable future. The Internet provides access to a vast wealth of information. The challenge is how to find a specific item of information hidden in that vast wealth.

An Internet WEB site refers to an entity connected to the Internet which supports WEB communications and/or WEB files. The WEB helps a user access various pages of information at various Internet sites. The WEB permits a user to display documents and to make links between items of information available. The difficulty is in easily targeting and going directly to a particular information resource. At the present time, one of the most difficult tasks in using the Internet or any other network is knowing what information resources are available and how to go directly to the specific information desired.

### SUMMARY OF THE INVENTION

The present invention provides an integrated WEB navigation means utilizing an information visualization-based method. The invention method addresses the problems that arise when Internet users are confronted with the massive quantities of information currently available on the World Wide Web. The method of the present invention eliminates the need for users to sort through overflowing textual lists, and instead allows users to visually guide themselves quickly and easily to the exact site, product or information desired.

The present invention provides a graphical gateway to a computer network. The invention method presents network information, i.e., main portals, categories, sub-categories, site search results, site ratings, etc., in a visual way. The method of the present invention presents site locations, according to categories, as a graphical state map. The same map may be topographical symbolizing a rating interest of each site. A network user can quickly locate a desired site through a visual search. Entry into the site may then be made by the user. The map of the invention method provides a user with added information regarding the network, including a site's general content, a site's services, surfing help, etc., all presented in a visual way with the help of map features.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 is a schematic representation of the three layers of the invention Web map.

FIG. 2 is a schematic representation of an upper map level.

FIG. 3 is a schematic representation of a main category.

FIG. 4 is a schematic representation of a group of subcategories.

FIG. 5 is a schematic representation of zoom feature in action.

FIG. 6 is a schematic representation of a map with icons.

FIG. 7 is a schematic presentation of an image on a map and grid.

FIG. 8 is a graphical representation of a map with an information box presenting an advertisement.

FIG. 9 is another graphical representation of a map with an information box presenting an advertisement.

FIG. 10 is a schematic block diagram advertising data flow chart.

FIG. 11 is a graphical presentation of a site map picture.

FIG. 12 is a schematic diagram of the invention method data float.

FIG. 13 is a schematic diagram of the service icon signing data float.

FIG. 14 is a schematic diagram of the invention method database construction.

FIG. 15 is a schematic diagram of a map, HTML page, and a second HTML page within a mini browser.

FIG. 16 is a graphical representation of a mini browser.

FIG. 17 is a graphical representation of a history window.

FIG. 18 is a graphical representation of a favorites icon.

FIG. 19 is a graphical representation of a first special toolbar.

FIG. 20 is a graphical representation of a first special toolbar menu.

FIG. 21 is a graphical representation of a first special toolbar favorite site drop down menu.

FIG. 22 is a graphical representation of a second special toolbar menu.

FIG. 23 is a chart of example buttons and controls provided by the second special toolbar.

### DETAILED DESCRIPTION OF THE INVENTION

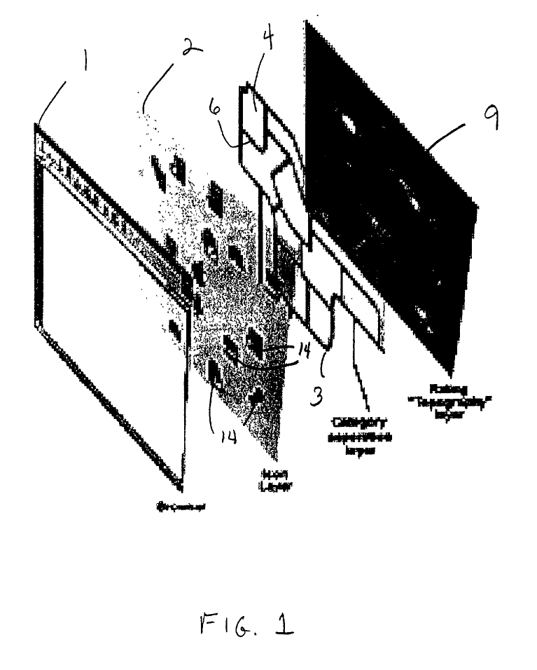

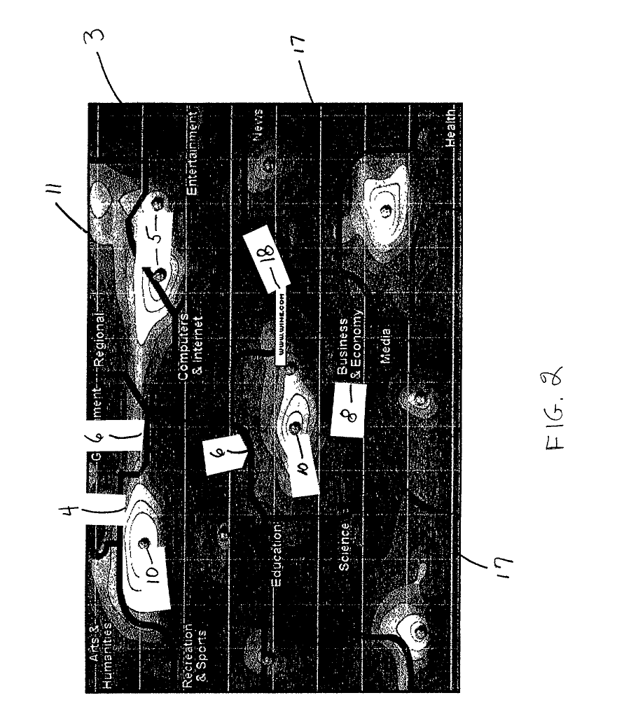

Referring to the drawings in detail wherein like elements are indicated by like numerals, the method of the present invention represents WEB information through a three-layer model. Each layer is used to represent information. A state layer 3 represents categories of information. A topographical layer 9 represents ratings, such as traffic or other kind of rating. A third layer 2, an icon layer, represents services, leading sites, search results and so forth. The invention method enables information to be represented via information channels dedicated to content, rating, and unique characteristics. See, especially, FIGS. 1 and 2, which illustrates a schematic representation of three-layer, a first level, state upper map level constructed according to the present invention method.

The present invention method is used in conjunction with an Internet browser. A visual representation of a typical Internet browser is shown at 1. The invention method provides a text representation of any WEB or network directory on a two-dimensional surface. Various distinct categories, a/k/a topics, included within the directory are spread across the screen and encircled by polygon-shaped borders. The result is a “state” map 3 created from a directory tree that has been mapped. The categories, e.g., art, business, computers, games, health, etc., are represented on the map by characteristic polygons 4. The polygon shapes 4 have been chosen as a familiar technique for users lending itself to memory facilitation and ease of orientation to the map. After using the map 3 for a short period of time, users will remember their favorite categories and their specific locations on the screen.

Each site 5 is presented on the screen as a pixel. A site 5 can be represented by an icon 14 as well. Every site's pixel is placed on the screen within the area of the main category that best suits the site 5. A site 5 that belongs logically to more than one main category is marked by more than one pixel and is placed in all of the appropriate categories. The pixels of the sites create a shape. This shape is the main category's polygon shape 4. A line 6 borders the main categories creating a visual impression of a state map.

Sites 5 included within the various categories 4 are located with respect to one another based on their content. The items found within the categories, i.e., WEB sites on the WEB Map, are located on the screen such that the closer they are in relation to one another the closer they are in content. The distance between sites is determined according to the relation between the sites. The relation between sites is determined according to the subject the sites deal with, and may be determined by key words or by any other method. Thus the location of a site on the screen, inside a category, and inside a subcategory, is derived from its content, which is determined by keywords or by other selected methods. The distance between two sites on the screen reflects the similarity or dissimilarity in their content. Sites are placed within a category not only according to their similarity to each other in content, but also according to their connection to the category center and borders. For example, if the category “business” is bordering the category “computers”, and there is a site that belongs to “business”, but, in its content it is closely related to “computers”, its location inside the category “business” will be close to the border 6 between “computers” and “business”.

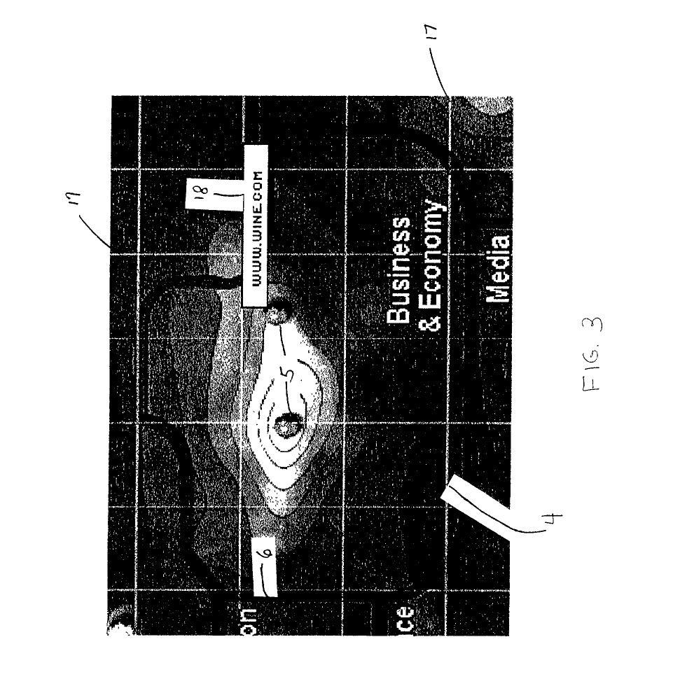

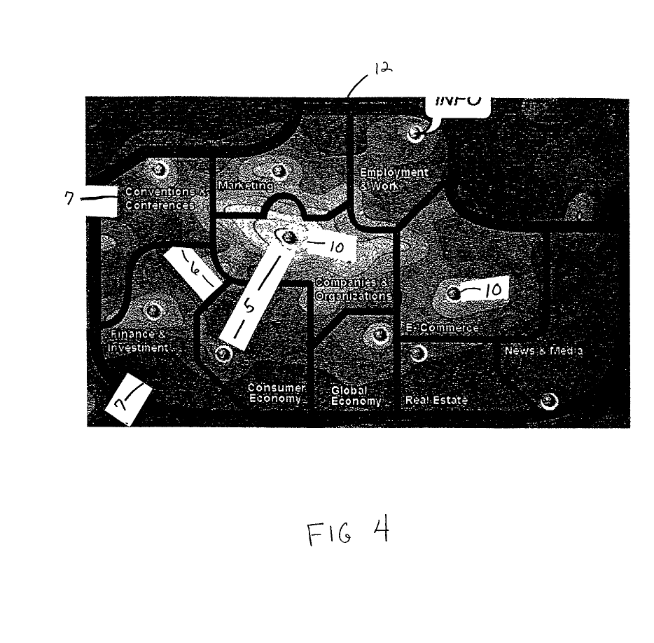

Every main category 4, e.g., FIG. 2, is generally divided into sub-categories. For example, a main category 4 of “Business & Economy”, e.g., FIG. 3, may be subdivided into sub-categories 7 such as “Finance & Investment”, “Consumer Economy”, “Real Estate”, etc. See, e.g., FIG. 4. Every subcategory represents a topic. Every site's pixel is placed on the screen in the area of the subcategory that the site 5 best fits into. A site 5 that logically belongs to more than one subcategory 7 is also marked in each appropriate subcategory by a pixel. The pixels of the sites create a shape. The resulting shape forms the subcategory's polygon shape. A line 6 borders the sub-categories thereby creating a visual impression of a state map. Every subcategory may be further sub-divided into sub-categories of its own. The resulting further sub-categories may again be further divided into smaller and smaller sub-categories. The limits of the subdivision process are decided according to the complexity of the category or subcategory, according to the number of sites included in the category or subcategory, and by the needs and desires of the user. The last subcategory presents a number of sites without any “state” divisions.

The mapping process is divided into map levels. The upper or first map level is a map that shows only the main categories. See FIG. 2. A text 8 placed inside the main category 4 shows the topic of the specific main category. The user can activate a zooming process on a specific main category. When the user activates the zooming process, e.g., on “Business & Economy” he will see a second map level. See FIG. 4.

The second map level is a map that shows only one main category that was chosen at the first level zooming process, e.g., “Business & Economy”. The main category is divided into subcategories as mentioned above. The user can again activate the zooming process on a specific subcategory. When the user activates the zooming process he sees a third map level.

The third map level is a map that shows only one subcategory that was chosen at the second map level zooming process. The selected subcategory may also be divided into sub-categories of its own as mentioned above. The user can again activate a zooming process on a specific subcategory. When the user activates the zooming process he will see a fourth map level. The process may be continued until there are no sub-categories left. At this stage what the user sees is a number of WEB sites. The number of map levels is a function of the complexity of the initial category and sub-categories chosen.

Each level of a map is identical to the others in its core structure. The process works both forward (zoom in), and backward (zoom out). The user may shift from a third map level to a second map level, from the second map level to the upper (first) map level, and so on.

An indication of map level appears at a special location on the computer screen. The use can activate an option, in which the upper (first) map level, which shows the main categories, appears at a special place on the screen. By using this option the user can see the upper map level while browsing other map levels.

Another possible option is that the upper map level shows sites that divide a large quantity of sites into categories (portals), e.g., Yahoo, Alta Vista, Snap, etc. The user may choose one portal. When the user does so, the second map level will show the main categories according to the chosen portal categorization. When a main category is shown at the next map level, the sub-categorization is according to the chosen portal sub-categorization, and so on. Further more, when the user chooses a portal, and enters a main category or subcategory with the zooming process, he may change the chosen portal. This change diverts the sub-categorization of the chosen category into the sub-categorization of the current portal. The sites' content of the category changes as well.

If categorization is derived from a portal's categorization, then the user can, at any time, shift to the portal textual presentation of categorization. The invention method aims to the specific HTML page that fits the site placement on the map. (WEB pages are written in a special WEB language called HyperText Markup Language (HTML)). If an upper (first) map level that shows portals is the chosen option, the map showing main categories is not the upper (first) map level but the second map level.

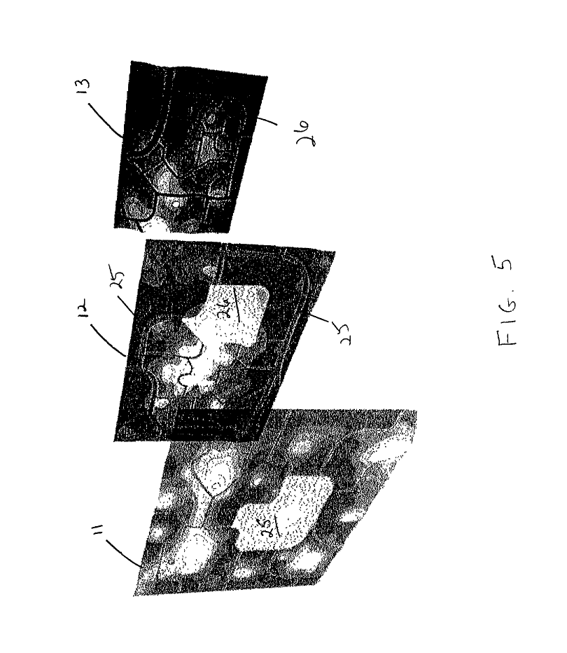

The invention method's second layer 9, not to be confused with map level, provides a third dimension to the first layer. The second layer provides a means for showing a “rating” of “value” for each site. The invention method represents each site with topographical features. The sum of a site's rating data is analogous to the height of a topographical map. The rating data is decided according to preselected parameters such as: the number of site visits by users, the amount of time users spend at the site, the links to the site received from other sites, and so on. The rating data can be determined according to the sum of actions done by users, or from an outside data source, such as “pcdataonline.com” reports. The more traffic a site experiences, the higher its representation will be on the topographical map. The topography layer may be utilized to display other forms of data such as recently updated WEB pages, or the frequency with which a specific word appears within a site. Every map described above includes topographical features. The topographical features are designed at every map level. See FIG. 5, a schematic representation of the topographical features of three map levels. The topographical features are maintained throughout the invention zoom process. An area 25 of a first map level 11 is zoomed into resulting in a second map level 12. An area 26 within the zoomed into area 25 is further zoomed into resulting in a third map level 13.

Referring particularly to FIGS. 1-5, during application of the invention method's first and second layers, a number of popular sites, i.e., approximately one hundred in this embodiment, create the highest spots on the first map level. These sites are indicated as mountaintops 10 on a topographical map. The selected sites 5 are scaled among themselves to create a difference between one “mountaintop” to another. The other sites obtain their height on the topographical map in a relative scale to the most highly rated sites. FIG. 2 is a good example of a first map level. . A color scale may be used to show visually the differences among the heights.

At the second map level 12, a number of popular sites is chosen. See FIG. 4. These sites 5 are generally not identical to the most highly rated sites shown on the upper map level 11. The second map level sites are the most highly rated sites in the chosen main category. These sites are similar to mountaintops 10 on a mountain ridge on a topographical map. At the third 13 and following map levels, a number of popular sites is again chosen. These sites are generally not identical to the most highly rated sites shown on the previous map level. This process continues until the final map level is reached. See, e.g., FIG. 5.

The invention method's third layer 2 provides additional graphical information in the form of icons 14. Numerous types of general and personal information may be represented as icons 14. This information may include the leading WEB site within a category, the search results presented from any search engine, personal bookmarks, a user's personal history, etc. This format allows WEB directories, search results and personal information to be coupled with a single screen to create a new and enhanced WEB navigation experience. An icon 14 stands for a site or a site service. FIG. 6 takes FIG. 4 and illustrates the sites 5 that the user visited marked with flag icons 15 and the user's favorite sites marked with arrow icons 16. Pressing the mouse button on an icon leads to an entrance to the site content and/or using a site's special service. Although a pixel represents a site, the pixel's size makes entrance to the site difficult. Thus, practically, the question whether a site is accessible at each map level is determined according to icon signing.

The invention method also provides a grid 17 behind each map. The function of the grid 17 is to improve, visually, the orientation of the user. See, especially, FIGS. 2 and 3.

The method of the present invention permits a user to choose a site, which appears on the map as an icon, and sign it as an image 18. See FIG. 3. The image 18 may be a textual information box 20 or a tool that pops up as a result of a roll over by a mouse cursor. The user may determine the exact placement of an icon 14 or a window 19 on the grid 17 directly or the invention method may determine the exact placement according to the user's convenience and the necessity to present other data. The location may be dynamic, thus the location may dynamically change according to other relevant data presentation necessities. Alternatively, the location may be static, thus placed at a fixed position on the grid.

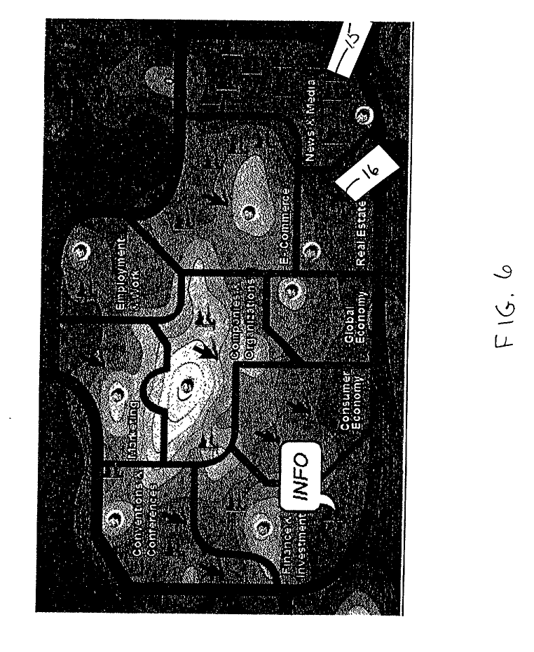

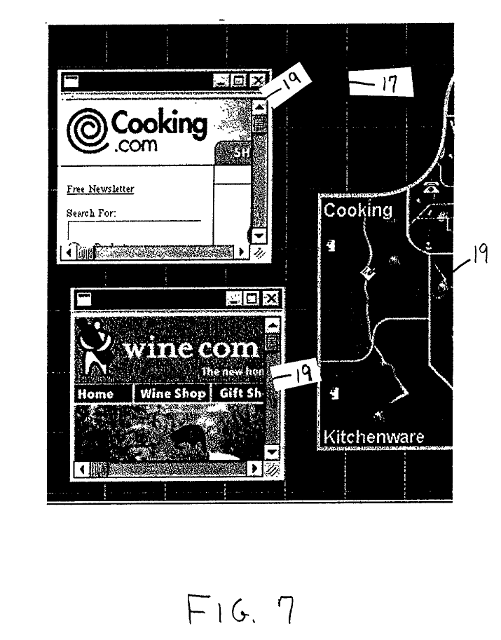

The image 18 may be presented as the site's logo. The image 18 may also be presented as a window 19. See FIG. 7. The invention method takes the site address from its database, connects to the site, gets the HTML page data, and minimize or edit the HTML page. The invention method presents this image only at a map level chosen by the user.

The user can maximize the size of the window 19. The maximization process increases the window's size to a full screen's size. From that moment on, the window functions as an HTML page that was opened by the user while activating the browser. The user can mark a specific subcategory, activate a function that increases this category's size, and locate it on the grid. This allows a zoom process without a change of map level. The invention method stores all images placed on the grid in a special caching structure, thus they become a part of the map level they were opened at. The user sees them every time he enters the specific map level they were placed in.

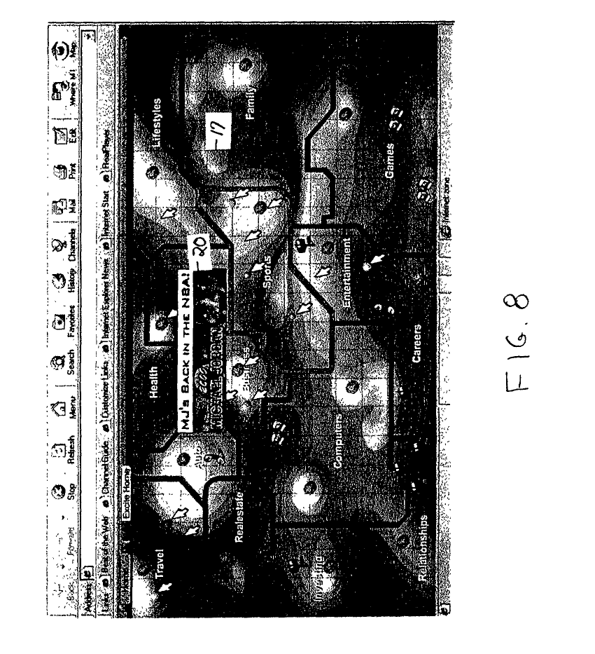

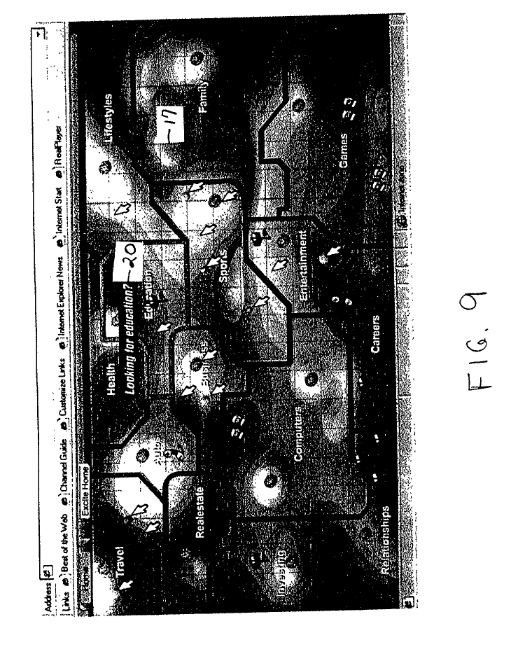

The invention method can also present output as information boxes 20. See FIGS. 8 and 9. An information box 20 contains data. This data may be a textual list, graphical data or even animation. The information box 20 is given in a quadratic frame. The location of the information box is derived from the location of the cursor, or may be located at a fixed place on the grid 17.

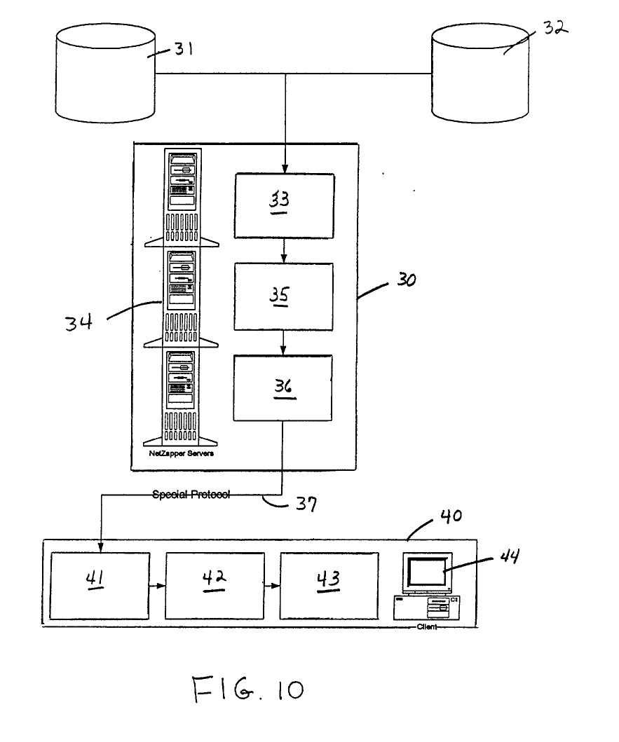

Referring more particularly to FIGS. 10 through 14, the invention method includes an updating feature since the invention method maps Internet data, and since this data often changes. There are two kinds of changes, i.e., general and personal. General changes are changes that reflect on all the maps. These changes are derived from changes of outer databases 50, e.g., such outer data bases may include portals like Yahoo, Lycos, etc., and changes of invention method data bases. The invention method 30 processes the changes and creates updating data. Each user's computer 40 downloads the updating data, processes it, and changes the map. Personal changes are changes that were done by a specific user and only influences that user's use. These changes need no downloading system. The changes are divided according to the three layer model.

Updating data on the first layer (the state map) are reflected by the addition and reduction of sites, i.e., sites that are added to the data bases and sites that do not function anymore and are taken out of data bases. Site placement may also be changed. Due to the addition and/or reduction of sites, the placement of both new and old sites change, since the sites are placed, in part, according to the connection between them. Categories may be added or reduced. This may include both main categories and subcategories at any map level. The size and shape of the categories may change. There may be a corresponding addition and/or reduction in map levels.

The second layer (the topographic map) also requires change. Due to the Updating data of ratings information, and due to the addition and/or reduction of sites, the changes of sites' placement, the change of categories size and shape, and the addition and/or reduction of map levels, the topographic features of map changes.

The third layer (the icons) may also change. The icons reflect both personal and general data. This data changes with time. The changes reflect on the map and may include addition, reduction, and change of icons.

The icons are divided according to their shifting ability between the different map levels, i.e., single level diffuser, multi-level diffuser, group multi-level diffusers, marker, and system icon. A single level diffuser is an icon type that shifts only one level, at any direction, between map levels, at a single data change. A multi-level diffuser is an icon type that shifts one level or more, in any direction, between the map levels, at a single data change. The multi-level diffuser icon type is the signing result of a service that directs the user to a site or sites on the WEB. Only the distance between the upper map level and the deeper map level limits the map level change ability of the multi-level diffuser. Group multi-level diffusers are group(s) of icons that shift one level or more, in any direction, between the map levels, as a group. This is the result of a single service action signing process or a single data change. The multi-level diffuser icon type is the signing result of a service that directs the user to a site or sites on the WEB. Only the distance between the upper map level and the deeper map level limits the map level change ability of the multi-level diffuser. A marker icon type is the signing result of a service that reflects on the map an action the user did on the WEB. Thus, the place of the marker icon type between the map levels diverts from the best reflection of the user's WEB activities. A system icon type marks an action done directly at the computer system. It can appear at any map level.

A service is an Internet conventional application. Services are included in the invention method. Some of the services included in the invention method are but visual presentations of existing services, but some are new services diverted from the visual nature of the invention method.

The present method provides a services function by a signing process. Signing is the visual output of a specific service within the services function. The visual output is projected onto icons, grid placed images and information boxes. The icon is encapsulated, or rendered, by the service into a graphical sign of a URL placed on the map. URL stands for “Uniform Resource Locator” and is the protocol for an address line used by Internet components to address each other and usually is used in the context of addressing a specific WEB page. A service within the services function may use several types of icons rendered by several types of signings, and a same kind of signing can be rendered on an icon by several types of services. An icon service signing binds, in most cases, a site (URL). For example, a global service icon binds a site that has a high importance rate at a given map level. The user has the ability to zoom in to any level of the directory, and expose themselves to further subcategorization, detailed topographical features, or a more detailed set of icons. This facilitates the process of customizing the map for the user. The more frequently a user opens and accesses a WEB site, the higher its icon will appear on the various levels of the map.

Icons project information. The location on a map presents the site that the icon stands for. Thus, clicking the mouse on the icon over the map activates the HTML page and the user accesses the site. The placement of the icon on a map presents the site's categorization. The topographical features background presents the site's rating. The signing shape of the icon presents the service that activated the icon presentation. The shape of the icon itself may present information about the site. For example, an icon designed like a site's logo may present information about a site's content; and an icon designed with the letters “NEW” presents a new site or product, etc. Typical examples of icon signing are as follows.

When a user is visiting an HTML page, and activates the “Where am I” function, the system automatically shifts the user back to the map, and there the “Where am I” icon marks the site the user just visited. In that way the user may know at each time “where he is” on the entire WEB.

The importance rating determines whether a site is marked with a “Global” icon or not. Only a limited number of such icons are allowed at each map level. Thus, only the highest importance rated sites get an icon at each map level. The invention method takes search engine search results and presents them on a map by icon signing. A user does a search according to key words and the search engine provides results. These results are site addresses. The present method signs them on any map level that is occupied by the user. The results are signed on the categories that the sites belong to. The visual form that is signed on the map is an icon signing. This provides the user with a visual tool, which helps him to locate the wanted result out of a large quantity of results provided by the search engine, since the user can see immediately to which category or subcategory the search result belongs.

The search engine used generally scales the results according to the relevancy of the key words given by the user. Relevancy is not the only factor used by the search engine, but is the main one. The relevancy scale, in most cases, appears at the search engine in the form of the textual sites addresses list order. Relevancy is reflected in the visual appearance of the signing by a color scale. For example, 80-100% relevancy may have red icons, 60-80% relevancy may have orange icons, etc. The result is a visual reflection of the textual search results according to both categorization and relevancy. All the sites that pass a certain relevancy are presented. The exact percent will be decided according to the number of icons convenient for the user to examine.

The invention method signs a minimum/maximum number of search results icons per category. Typically, this is a minimum of 5 and a maximum of 30. The minimum number is reached always, even if the sites in the category do not pass the average relevancy percent mentioned above.

The user can activate a zoom-in process on a specific category. Only sites that belong to the category that is zoomed are signed. The process begins at the chosen category. All the sites that pass a certain relevancy percent are presented. The invention method signs a minimum and maximum number of icons per subcategory. The user may continue the zooming process.

The user can use a service that signs the relation between the search results and the last site visited by him. This signing is done by drawing lines (not necessarily straight) that connect the “Where am I” arrow with the icons that sign the most related search results site.

This service adds information to the conventional search results. This added information is the amount of relation between the search results and the last site visited by the user. This added information improves the user chance to locate a wanted site out of a large quantity of search results.

The invention method can also create a “Personal History” signing wherein icons may be signed according to their importance, i.e., importance being derived from frequency of user visits and time between visits. A user may also sign a list of favorite sites by book marking a site directly on a map or by signing a page while visiting a site as a favorite page.

The invention method stores in the user's cache a list of the sites the user visited, ordered by frequency and time. The history service includes two types: the map and the browser (filter). The map type is activated constantly. The level in which the icons are signed is determined according to their importance. importance is derived from the frequency the user visits them and from the time passed from the last visit. These icons are single level diffusers, because the user's action can shift them only one level up or down per personal data updating.

If the user visits a site signed as a global site, the signing changes from “Global” to “Personal History”. If the user visits the site enough times (determined by the user), the site may use the single diffusion ability and shift one level up, in the direction of the upper level map. If the user does not visit this site enough times (again, determined by the user), the site shifts one level down, and the signing changes from “Personal History” to “Global”. Since the icon signing symbolizes a site URL, the icon appears at the main category in which the site fits into.

The sites that the user visits while using the invention method are added to the history list of the user's browser. Thus, the user can get A textual version of his history, combined with his former list.

The filter type, in contrast to the map type, does not hold a constant structure of history icon signing on the map but uses group multi-level diffusers icons to set up a general map search results “look a ‘like’”, picture of the history situation. This service can be activated from the map special toolbar and from the browser. When it is activated form the browser, the user chooses the period of time in which he wishes his personal history to be presented, e.g., one week, two weeks, etc., and the site he looks for.

When the map is activated, and the user uses the browser's history function, the invention method shows the sites included in the browser's list visually. When the user places the cursor over one of the time categories included in the browser's history list, the sites included in this time category are presented as other type of icon signing on the map among the general filter type signed icons. When the user places the cursor over a specific site in the time category list, the site icon is signed on the map with another signing, as well as when rolling over the map itself.

The invention method imports on installation the existing user's list of favorite sites from the browser to create the initial map favorite structure. The user may add items to this list using either of the following methods. The user may book mark the site directly on the map. While visiting a site, the user can sign the page as a favorite.

The map type history service signing structure is presented continuously over the map levels. The icon signing position delivers its category (according to the placement on the map at the category the site fits into) and its rating (according to the map level and the topographic features on the background). The level and position in which a favorite site appears on the map may be chosen by the user, i.e., when adding to favorites from a site page or from the map, or may be determined by the invention method itself, i.e., if it's one of the sites that is taken from the browser list. The user may also determine a favorite site position on the map by a drag and drop or by a keyboard action over the map itself.

The invention method uses the existing user's list of favorite sites to create the map favorite structure. The filter type, in contrast to the map type, does not hold a constant structure of favorite icon signing on the map but uses group multi-level diffusers icons to set up a general map search results “look a ‘like’” picture of the favorites. This service can be activated from the map special toolbar and from the browser. When it is activated from the browser, the user opens his favorites category that he wishes to be presented and the site he looks for. When it is activated, the user opens the invention method categories that enforce the icon signing. The invention method presents the favorites at the same map level the user is in while activating the service icon signing. In cases of many sites, the icons are signed as dots.

Since the signing is attached to a site, it appears at the main category and/or at the subcategory in which the site fits into. Only the sites that are relevant to the same map level the user is at are presented. Thus, the invention method is used as a strainer. It does not present sites from irrelevant categories.

The favorites service icon signing is attached to a visited site, and at the same time delivers its categories and its rating. Category is according to the placement on the map at the category the site fits into. Rating is according to its placement on the topographical features. This provides the user with an easy and visual method for detecting a wanted site from his favorites, according to the categorization. The sites that the user bookmarks while using the map are not added to the favorites list of his browser.

When the map is activated, and the user uses the browser's favorites function, the invention method shows the sites included in the browser's list visually. When the user places the cursor over (or opens) one of his categories in the browser's favorites list, the sites included in this category are presented as other type of icon signing on the map among the general filter type signed icons. Sites that are inside this list, but can't be marker on the map at the current time because they are not included in the specific category that the user visits at the present time are not presented. When the user places the cursor over a specific site in the time category list, the site icon is signed on the map with another signing, as well as when rolling over the map itself.

When a new site appears on a map level, the invention method will present this site signed with an addition to thew icon signing. This addition is the “new” icon. The user receives immediate visual information about the new sites, and at the same time the icon delivers the site's category and subcategory (according to the placement on the map at the category the site fits into), and the site's rating (according to its placement on the topographic features). This provides the user with an easy and visual method for detecting a wanted site from a large group of new sites, according to categorization and rating. Another “new” icon addition may be used to deliver information about a new product the user may purchase at a specific site.

As stated above, the invention method uses a rating database to create the topographic features of the map. Using this database, the method detects sites that attract the largest quantity of users at the specific moment that the user requested the service. When the user activates the service, the invention method signs the most rated site at the same moment with the “What's hot” signing. If the service is activated at the upper level map, the method signs the site that attracts the largest quantity of users at the given moment out of all the sites in the database. If the service is activated at a specific category or at a specific subcategory, the method signs the site that attracts the largest quantity of users at the given moment out of all the sites in the specific category or subcategory.

When the user activates the “What's Related?” service, the invention method will place “What's Related?” service icons. These icons present the sites that are most related to the last site visited by the user on the HTML over the map inside the browser, or at a certain map level. When the user chooses, the method can draw lines (not necessarily straight) between these “What's Related?” icons, and the “Where am I” arrow, thus emphasizing the amount of similarity between these sites and the last visited sites. This service's purpose is to solve the following problem. Users tend to reach sites that are similar to a wanted site, but have a minor content difference. This minor content difference causes a search failure. Without this service, the user must either begin the search all over again, or look for a link in the HTML content of sites.

The invention method also provides “mountaintop” icon signing. This icon symbolizes a general site of the upper level map at the deeper levels of the map. It may include the second level, or even the third, depending upon the user's needs. The graphical design of the icon in this embodiment is a small transparent triangle, and it may include the rating mark as a small size text beside it. This icon corresponds to the mountaintops sign on geographic maps, and the rating mark corresponds the height of the mountain. A general site at the upper map level is still a general site at the fifth map level, but it cannot be recognized among the other general sites of the fifth map level, because they are all general sites. The user may want to know whether a site among all the general sites is so highly rated that it was one of the upper map level's general sites. The “Mountain Top” icon solves this problem.

The user can activate, on a specific subcategory, a “Shortcut” service. The service signs an icon on a map level, which is closer to the upper level map then the chosen subcategory. While clicking this icon, the user shifts immediately to the map level in which the chosen subcategory is placed. With this service the user can reach deep map levels with one mouse click, thus avoiding a long zoom-in process.

Some sites provide periodic issues of magazines, corresponding to the paper format or a pure Internet version. The invention method presents as a graphical icon on the map, at any level and/or any main category and/or subcategory, every site that provides or issues an E-magazine service. Thus, the user obtains visual information about the service, about the site's categorical location and rating. When a new edition of the E-magazine is published, and if the user has subscribed to the service, the following happens. The invention method uses the multi-level diffusion ability of the icon and shifts the icon to the upper map level, thus ensuring that the new edition is visible. The invention method also changes the signing of the icon, thus the user knows about the new edition from the change at the icon graphical signing.

The invention method also provides “Chat” service and icon signing. Three possible sources that supply chat services exist: sites that include chat rooms; installed programs, e.g., “ICQ” program; and the invention method, itself. When someone tries to summon the user for a “chat”, the invention method activates the “Chat” service. The Chat service signs the char request by the “Chat” icon. The icon is preferably signed close to the upper map level, thus ensuring that the chat request is visible. The user chooses the exact level. If the char source is a site, the invention method uses the multi-level diffusion ability of the icon and shifts the icon much closer to the upper map level, thus ensuring that the chat request is visible. Chat rooms can be categorized whether their source is a site or not, since the chats themselves have specific subjects. The invention method signs the chat icons at the categories and subcategories that they fit into, thus ensuring immediate visual exposure to the content of the chat room. The placement of the chat icon on the topographic features reflects the rating of that chat room.

The invention method provides “E-mail” service and icon signing for three situations. The first situation is where the sites provide more services than the content of the site itself. Such services may include E-mail services. When the user chooses to use the mail services of sites included at the map, the invention method, which stores such data in its databases, may present on a map, at any level and/or any main category, and/or subcategory, the site that includes the E-mail service as a graphical icon. Thus, the user obtains visual information about the service, about the service supply site's categorical location, and about the service supply site's rating. The user obtains, through a visual signing change of icon, a message about a new mail.

The second situation is where the user has a special program which manages his E-mail services. The invention method can classify the user's E-mail in-box content according to the invention method map categorization. The user obtains his mail from outer sources. Data about the subject classification of such mail exists. The source of data may be the general invention method database or the user's preference. Database information might categorize E-mail from a hardware manufacturer as “computer” and the subcategory “hardware”. Preference might categorize E-mail from John Smith as belonging to the main category “science” and the subcategory “biology”. The invention method signs the E-mail icon on the map according to the categorization diverts from such data. The user obtains, through visual signing of the icon, a message about a new mail.

The third situation is where the invention method, itself, manages the E-mail of the users. The categorization of the E-mail is an integral part of the invention method E-mail service. Thus, the invention method signs the icon at the categories and subcategories it belongs to.

Sites provide downloading options. When the user activates downloading process, the invention method signs the downloading site with a “download” icon. The signing place of the icon on the map diverts from the categorization of the site. Due to this signing location, the user can trace the downloading process more efficiently. The invention method signs the icon at the upper map level, thus the downloading process is visible to the user during his work with the map. The user obtains, through a visual signing change of the icon, information about the downloading process progression.

The invention method also provides an “Internet-Telephone” service and icon signing. This service binds outer program telephone service. The user decides which category he wishes any specific call to appear in. The user chooses a map level in which he wishes the icon to appear in. When the outer program sends information about a call accepted, the invention method signs an icon at the category that was chosen by the user. For example, the user knows a phone call from Mr. X deals with cars. Any calls accepted from Mr. X are signed at the car category.

The invention method also provides an “Auction” service and icon signing. This service binds sites dealing with auctions. The user enters information to the invention method about a specific product transaction. The invention method signs the highest current price offer at real time. The icon delivers information about the highest offer and about the sale status.

When the content of a site changes, the invention method will present this site marked with an addition to the icon signing. This addition is the “Information update” icon. The user receives immediate visual information about a content change, and at the same time the icon delivers the site category, subcategory, and rating.

Some sites broadcast live media, e.g., virtual radio stations, virtual television stations, etc. When the user chooses to do so, he may activate a “Broadcast Reminder” service. The user enters the date and time that he chooses. The icon will not be visible until that exact date and time. At the specific date and time, the icon appears, and signs the user that the date and time that he selected had arrived. The user may use “Reminder” services for purposes other than live media.

The invention method provides a “personal link” service and signing. This service binds two pages in two different sites. When the user wishes to create a visual link between pages of two sites, he activates this service. The user may wish to use this service because the two sites are not linked or because he wishes them to be linked visually. The invention method signs a line between these two sites. Every time the user activates the link he shifts from one chosen site's page to the other.

The invention method provides a registration service and icon signing. This service binds sites demanding registration process. When a site demands such a process, it is signed with a “Registration” icon signing. Thus, the user obtains visual information, and he is informed about the registration necessity.

When information streaming of HTML, audio, video or other media type is congested on its way to a site on the map, the site is icon signed by a congestion service.

The invention method also uses logos, also known as favicons, to present sites on its WEB map. A logo is a graphic mark that stands for a site. Such logos are already in use and are part of the information that is included in a site's home page data. The advantage of logo presentation is the ability to identify at a glance the sites they mark. Combined with other features of the invention method, logos provide the user with the following information: which sites he looked at, the sites' category, similar sites, and site rating.

A logo may be used in three ways. Firstly, every time a site should be marked as an icon by a specific service, the graphic mark may be the logo. For example, the global icons may be marked as the specific site's logo instead of a generic logo. Secondly, every time a site should be marked as an icon by a specific service, the graphic mark may consist of a logo and an addition. For example, a site that is signed by the history service may be marked by the specific site's logo and an addition that stands for history. Thus, the user can identify at a single look both which site it is and the map context. Thirdly, sites in the last map level are presented as icons. These icons may be site logos, thus allowing immediate visual identification of the site's identity.

As stated above, the invention method provides information boxes. An information box is an output method that delivers information connected to an icon or a pixel on the map. The icon or pixel stands, in most cases, for a site, and the information supplied by the information box is related to the site that the icon or the pixel on the map stands for. There are several cases in which the icon or the pixel stands for a different object then sites. On the map itself there are icons that stand for content that is not a site. For example, the “Chat” icon can stand for a person in which the map user chats with. Thus, the icon represents this person, and the information box would relate to this person. The invention method applies the same technology that has been used to map the WEB in order to map the content of individual sites. The icons on the individual site maps stand for inner site content. Once the user's cursor is rolled over a pixel or an icon that stands for a site (or other object, as explained above), an information box appears. The information box is located next to the icon or pixel that stands for the site.

Information boxes may have several types of content. One type of information box includes textual information connected to the content of the site. The textual information may or may not include an advertisement. An information box may include a graphical picture connected to the content to the site. Such picture may be a product if the site is an E-commerce site. The picture appears on the screen for an amount of time. This amount of time may vary from picture to picture according to the user's needs, and/or advertisement needs. An information box could also include an animation effect connected to the content of the site.

The information box location is determined according to the location of the pixel or icon that stands for the site. Since the site is located according to its content, the information box location is determined according to its content.

The invention method is also adapted to present advertisements on the invention WEB map. When this feature is activated, whenever the user rolls his cursor over an icon or pixel that stands for a site, an information box 20 that functions as an advertisement banner 21 pops up. The banner 21 may include text, graphics or animation. The banner location on the user's screen would be next to the icon or pixel that represents the site.

As shown in FIG. 8, if the user is interested in sports, rolls his cursor over the polygon that represents the category “sports”, and rolls his cursor on an icon that represents a specific site, that deals with the basketball player “Michael Jordan”, the banner that advertises the content of the site pops up. As shown in FIG. 9, if the user is interested in education, rolls his cursor over the polygon that represents the category “education”, and rolls his cursor on an icon that represents a specific site, that deals with Education options, the banner that advertises the content of the site pops up. Since the banners that pop up are banners that advertise the sites that the user rolled his cursor on, the user is exposed only to advertisements in his own area of interest. Since the user's aye and attention focus where his cursor is located, the user looks exactly where the banner is located.

Referring more particularly to FIG. 10 there is shown a schematic block diagram advertising data flow chart. An advertising networks banners data base 31 is established with specific advertiser banner information 32. The information is passed to the invention method 30 and converted and adjusted 33 to invention method format. This is done within the invention method servers 34. The servers 34 match 35 the banner and the advertised object on the map. The banner 20 location on the user's screen 44 is determined 36 according to the location of the advertised object on the invention method map. Through a special invention method protocol 37 the advertising information is sent to the client's computer 40. When a user enters a specific map level, the information of this level is sent 41 from the invention method server 34 to the client 40, including the banners and the banner location. The user rolls 42 his cursor on the advertised object. The banners pop up 43 at the location determined by the server.

The information regarding the advertising banner is being directly transferred from advertisers to invention method servers. The transfer method is a normal WEB information transfer method. Once the advertising data reaches the invention method servers, it is adjusted to the data format being used by the server. The servers match the banner data with the advertised object data. The banner location on the map is determined according to the advertised object location on the map. The banner information is transferred from the server to the client. The transfer method is a special invention method protocol to transfer all its data from the client to the server. Once the user zooms into the map area in which the banner is located, the banner 20 pops up on his screen. See FIGS. 8 and 9.

The invention method uses the same process used for Internet mapping for the inside map of sites. The categorization is used for the inner categorization of the site. The topographic features can apply to the most rated parts of the site. The icons layer may be used for emphasizing parts of the site such as special HTML pages, audio effects, graphic effects, animation, etc.

While navigating with the invention method inside an E-commerce site, the user is exposed to products and services. These products and services correspond to the sites on an ordinary invention method map. The E-commerce site's WEB master can change the categorization and ratings according to his will, thus make some site parts and some products more accessible that others are. The graphic banners 21 would typically be used to give a consumer information about specific products. Such information may include textual information, pictures of the product, and animation effects. See, e.g., FIG. 11.

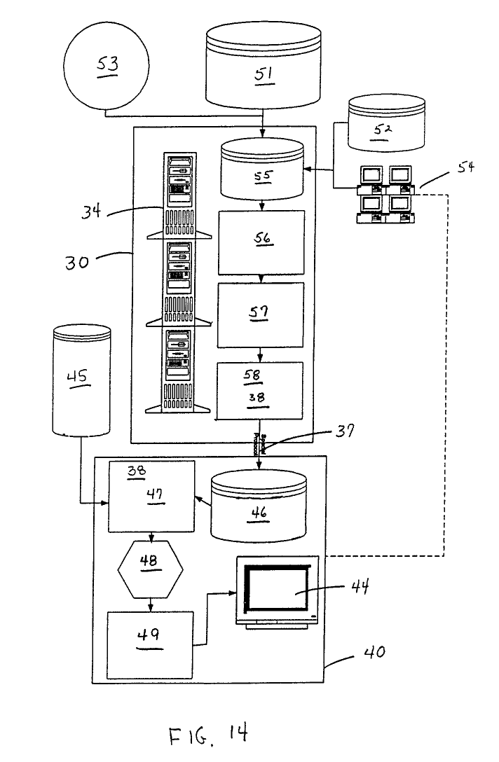

Referring more particularly to FIGS. 12 and 14 there is shown a schematic diagram of the invention method data float (FIG. 12) and the invention method data base construction (FIG. 14). Data is obtained from numerous sources in order for the invention method to prepare its various maps. A substantial amount of data come from sources grouped generally as “Outer Data” 50. Outer data can be of three general types. Outer data 50 would include data that categorized site addresses, e.g., the open directory project, Yahoo.com, etc, 51. The open directory project (WWW.DMOZ.ORG) includes information about approximately 1.4 million sites, including site categorization. Outer data 50 would also include data sources that provide ratings 52, e.g., PC DATA ONLINE. PC Data Online Inc. (WWW.PCDATAONLINE.COM) provides, in its public reports, the most visited 500 sites on the WEB. Outer data 50 would also include data from sites which provide information about their own nature, thus connecting their signing to a specific service. For example, site X deals with chats. Site X makes this information available to the invention method. This information is inserted into the invention method servers. From then on, site X is connected to the invention method chat service. The chat service signs the site on the map as a chat site. The invention method clients deliver the number of visits per site done by the user. The amount of visits per site influences the site ratings. This rating is needed for the second layer map, and for determining which sites are signed as Global icons. Users also provide, manually, sites address and categories 53. User client software provide sites visited by the users 54, thereby influencing those sites' ratings.

The invention method servers process all of this data and send it to the clients. Every client map is drawn according to this data. The invention method 30 first makes up a data base 55 wherein all the sites are categorized and some have ratings data. The invention method 30 then passes the data from the data base 55 through a category creation algorithm 56. The algorithm 56 takes the directory tree from the data base 55 and creates category shapes and location. The data is then passed to a sites location algorithm 57 which locates sites inside the categories according to their content. The data is then passed to a services algorithm 58 which determines which sites are signed as icons at each map level. This information is all sent via a special invention method protocol 37 to a user data base 46 in the client's computer 40. The user data base 46 includes site addresses and categories of the first and second level of the map, and the other map levels that the user zooms into. The data base 46 information is accessible by a local services algorithm 47 which determines which sites are signed as icons at each map level according to local demands, e.g., history bookmarks. An outer program data base 45 e.g., the last visited sites list of Internet Explorer 5.0, may also be needed by the local services algorithm 47 for the history service. The user then zooms 48 to a specific map level. The information is then taken by a topographical algorithm 49 which creates topographical features according to the ratings data. The data is then presented on the user's screen 44.

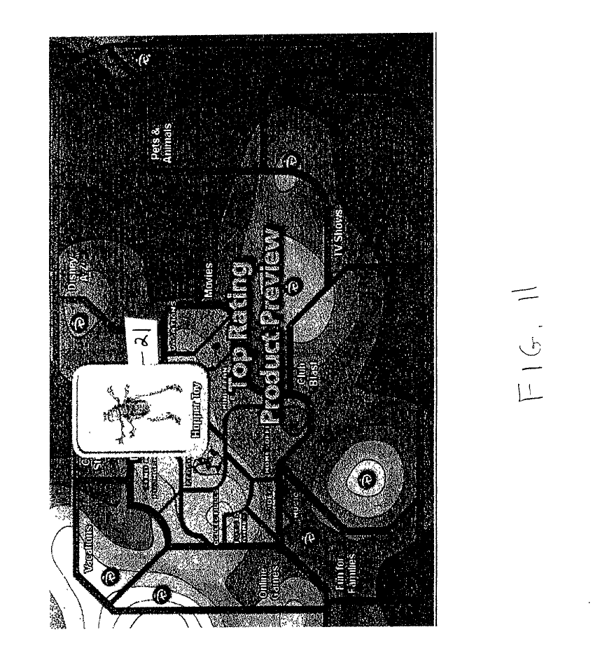

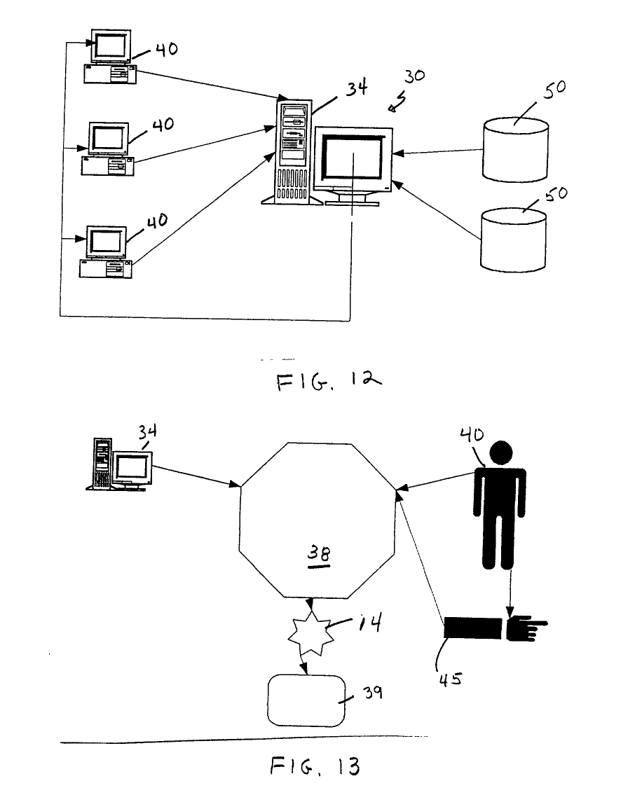

FIG. 13 illustrates the data float during the service icon signing process. The invention method service 38 generally obtains its input data from two main sources, i.e., the invention method servers and the invention method user. For example, the global service obtains its data only from the server. This data is comprised of which sites are the highest rated sites at a certain map level. Input data from the user can be delivered directly or from an outer program 45. For example, if the user wants a site to be signed as a chat site, he directs the invention method to sign this site as such a site. An example of an outer program 45 would be the history service using the visited sites data from Microsoft Internet Explorer.

The invention method service 38 creates an object as output. This object is the icon 14. The icon has a certain location on the invention method map. The location includes a map level or map levels in which the icon is located, and a place inside a category at a specific map level. The icon is signed graphically on the map in the signing process 39.

The invention method is primarily oriented to networks. Although there are many techniques for implementing the various invention method functions, the present embodiment of the invention attempts to use traditional tools for implementing its various functions.

The initial installation of the invention method will add two buttons to the existing browser tool bar 60, i.e., a “Where am I” button 61 and a “MAP” button 62. See FIG. 15. FIG. 15 is a schematic diagram of a map, HTML page, and a second HTML page shown within a mini browser. The “Where am I” button 61 activates the invention method map program, the “Where am I” arrow and icon signing. This button 61 also activates any services that start automatically when the map is activated, e.g., search results service icon signing, E-magazine service icon signing, chat service icon signing, E-mail icon signing service, and download service icon signing. This button 61 also includes the following function. When the user activates the browser, and the map is not seen by the user (because the program is inactivated or because the current HTML page covers the map's location on the screen) and the placement of the “Where am I” arrow on the map changes (because the user shifts from one site to another) then the graphical symbol that stands for the button flashes. The “MAP” 62 button toggles the HTML 63 engine on and off. Of course the special windows 19 and 65, i.e., mini-browsers, are added as well.

The browser's tool bar 60 remains without change except for the two additional buttons described immediately above. The text boxes that the browser program uses for textual information delivery remains without change, The place on the browser screen, intended to accommodate the HTML page, is now occupied by the invention method map 64. This place on the screen is occupied by the invention method map in the following situations. Every time the user presses the “Where am I” button 61 and activates the map 64, and hides the HTML layer 63. Every time the user activates the browser, until the home page is downloaded, as a regular routine.

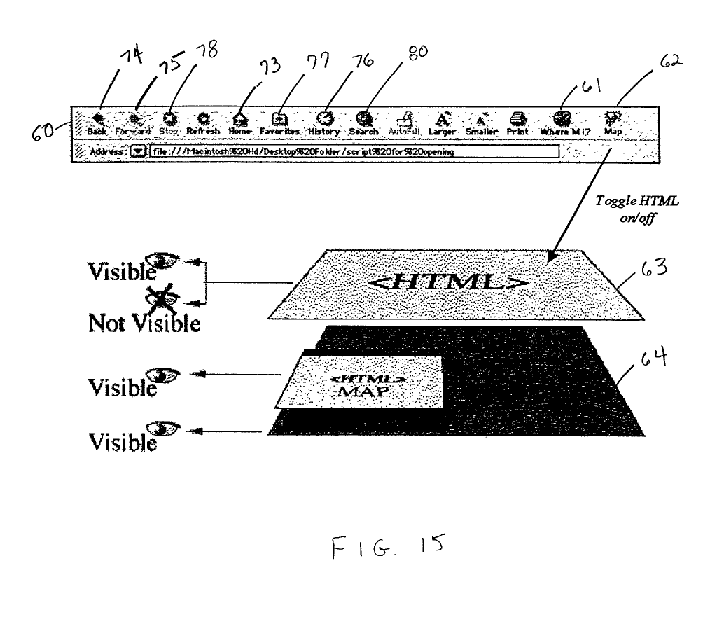

The invention method map provides the option to open sites inside special windows 65, termed small map windows, over the map surface. See FIG. 16 which illustrates a mini browser. The content will be HTML rather than a map. These small map windows 65 act as mini-browsers and it is possible to actually “surf the web” inside them. For this purpose, the window title is acting as a minimal browser toolbar with four actions identical to an ordinary browser's functions, i.e., back 66, forward 67, refresh 68 and stop 69. The window will also supply other normal window control such as: close window 70, minimize to icon 71 (minimize the screen into a special icon on the map surface), and free scaling (bottom right corner) 72.

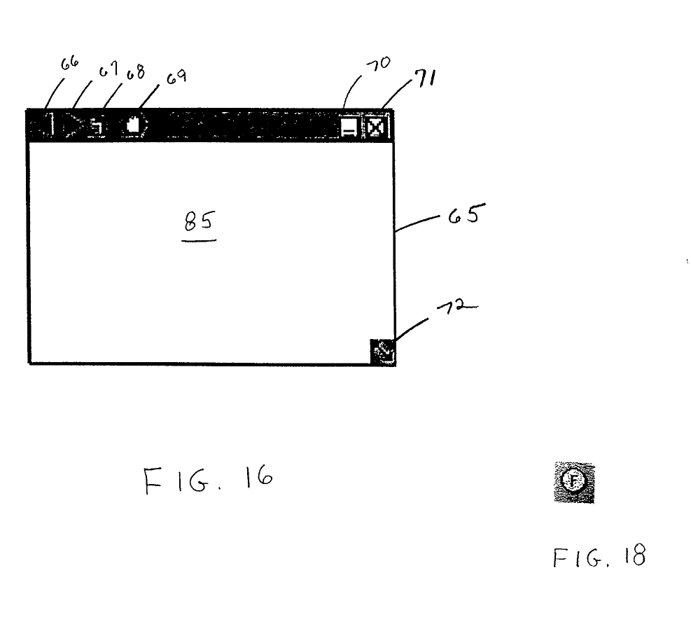

The browser's tool bar functions do not change, but while the invention method map is activated, this tool bar activates functions in the invention method. The functions are described as follows. FIG. 15 illustrates the tool bar. The “home” button 73 activates the HTML layer and opens the user's selected HTML homepage on both modes (map/HTML). Thus the “home” button 73 remains without change in all cases. The “back” button 74 has similar functions regardless of the mode. The invention method stores data about the zooming process the user activates. When the “back” button 74 is activated, this data is used to shift the map back to the previous state before the last zooming process (whether zoom-in or zoom-out) was done. For purposes of the “back” button, zooming process includes any shifting of map levels, whether done by ordinary zoom process or by another function, e.g., the “Shortcut” service. The “forward” button 75 shifts the invention method to the map level seen by the user before the “back” button was activated last time. The “history” button 76 activates the personal history (browser type) service icons signing. Data is obtained, from among other sources, from the browser's existing history list. The list is changed during the history service activation. The history function acts normally, i.e., clicking a URL opens the relevant HTML page. But when opening the history window, the selected history will be represented on the map with special icons, and rollover action over the history URL's will highlight the matching location on the map surface and vice versa. It is not a history window alone, but the interaction of a history icon with a history side bar, such as the history side bar provided as part of the Microsoft Internet Explorer browser application. See FIG. 17. The “favorites” button 77 activates the favorites service icons signing, and acts exactly as the history action does, but with different icons for the favorites sites. See FIG. 18 for an example icon. The “stop” button 78 does not change. The “refresh” button 79 reloads from an invention method server all data to map category, including HTML data in currently open SMWs. The “search” button 80 activates the user's default WEB search service, and thus, remains unchanged.

All of the functions listed above may be activated by a special toolbar provided by the invention method and having no connection to an existing toolbar. In addition to these functions, all of the functions mentioned previously which are activated by clicking combinations on the map itself, have corresponding activation possibilities on a special toolbar.

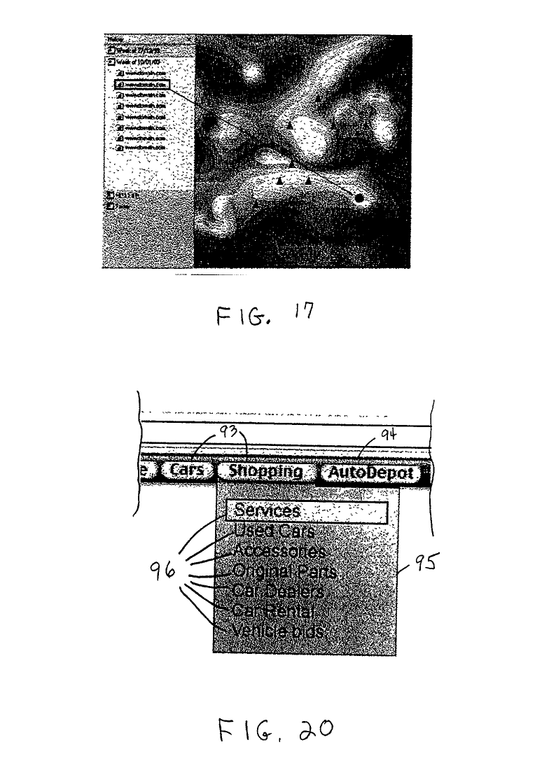

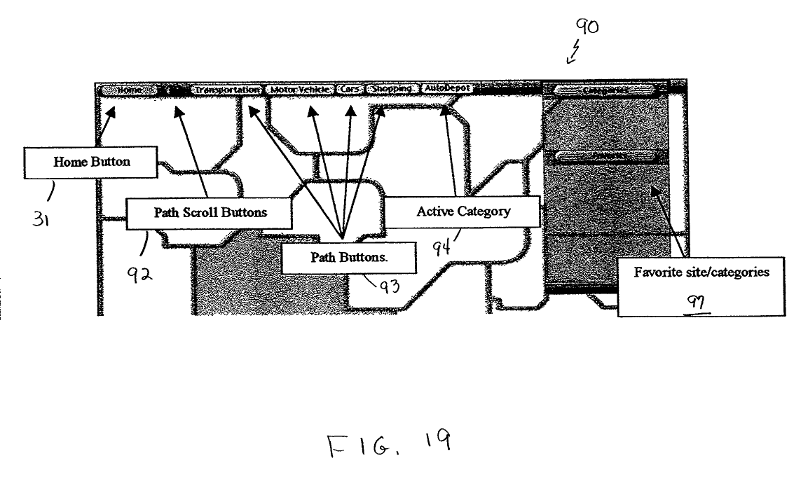

FIG. 19 illustrates a first special toolbar 90 which is termed a “path/history” toolbar. The purpose of the first special toolbar 90 is to show the navigation path in a graphic form and appears only when the browser is in “map” mode. The “home” button 91 will always appear on the toolbar. Activating this button 91 shifts the map to a home level map. Path scroll buttons 92 enable the scrolling of a path (left/right). Path scroll buttons 92 are disabled if path buttons 93 (see below) are graphically shorter than the toolbar. Path buttons 93 textually represent map levels according to the main categories textually represented that the user visited before entering the current map level. By activating one of the path buttons 93 the user enters the map level textually represented. The active category button 94 represents the current open map level's main category. Referring also to FIG. 20, there is shown a menu on the first special toolbar. Left clicking each of the path buttons 93 will pop a menu 95 with the residing categories of each level. See FIG. 20. Selecting one of the items 96 on that menu 95 will show the map of the relevant category.

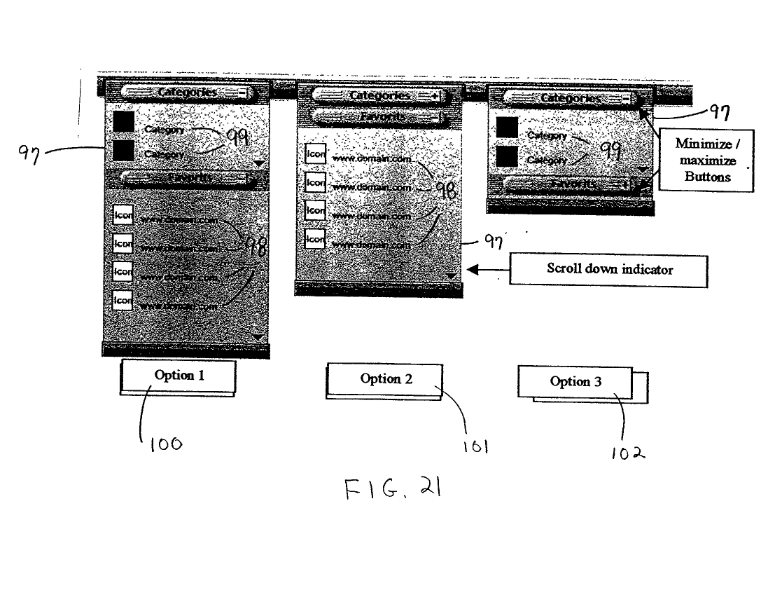

The first special toolbar also has a favorite category/site drop down menu 97 containing all favorite sites 98 relevant to the current map level. See FIG. 21. When the user opens this menu, and rolls over the favorite sites, the map highlights the rolled over site on the map surface. Adding favorite sites to the list is done as follows. On both modes (map or HTML) adding a favorite to the browser favorite site list also adds the site to the map list at the relevant category. While the map mode is activated, selecting “Add to Favorites” or “Add Bookmark” on the browser menu, will add the favorite site to the map favorites only. While on “Map” mode, dragging an icon to the drop down menu location will add it to the list. The favorite category drop down menu will contain all personally chosen categories in lower hierarchy then current category, and if chosen, will act as a shortcut to selected category. The favorite category/site menu 97 can be set according to three options. Option 1 100 shows categories 99 and favorite sites 98. Option 2 101 shows a category header only, but lists the favorite sites 98. Option 3 102 lists categories 99, but only shows a favorite site header.

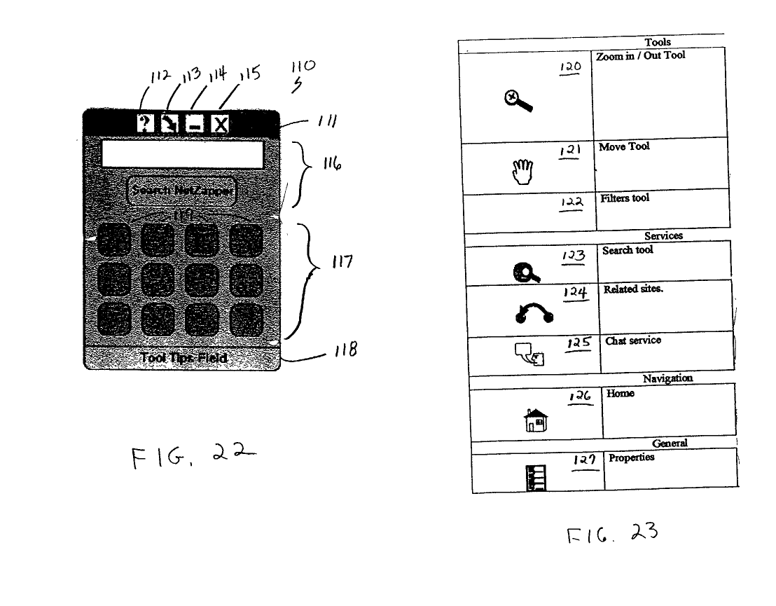

FIG. 22 illustrates a second special toolbar 110. This toolbar is a “floating—always on top” toolbar in a windows environment. The second special toolbar 110 is active without any connection to the browser's window, and does not need the browser to be activated in order to be active. If the browser's window is not activated, every operation on the toolbar automatically activates the default browser chosen by the user. The second special toolbar 110 has a generally rectangular shape. A top section 111 provides toolbar control and has four buttons providing help 112, shrink to shortcut bar 113, minimize toolbar 114 and close toolbar 115. Just below the top section 111 is a search section 116. Below the search section 116 is a toolbar box 117 comprised of 12 buttons 119. Along the bottom is a bottom section 118 providing toolbar tips and online help.

FIG. 23 provides a chart of example buttons and controls provided by the second special toolbar 110. Clicking the zoom-in/out tool 120 over a category surface zooms into the selected category. The user may also zoom out one level by manipulation of the ALT command. Selecting the move tool 121 and then clicking and dragging the mouse over the map surface will scroll the map in two dimensions. The filters tool 122 sets the wanted services filters to show or hide certain filters. The search tool 123 opens the toolbars search function 116 and searches invention method sites databases. Clicking the related sites button 124 activates the “most related sites” service. Activating the chat service button 125 opens a chat window with other WEB surfers in the same sites. Clicking the home button 126 will open the browser in map mode in default or a user selected home category. The properties tool 127 sets general behaviors of application and other parameters.

The invention method provides mouse functions. Mouse movement controls a cursor, the cursor being capable of moving all over the screen. While the cursor is rolled over a toolbar button, clicking the left button activates the toolbar's button. While the cursor is rolled over the map surface, clicking the left button activates the zoom-in process. While the cursor is rolled over the map surface, the cursor rolls over pixels and icons. If the cursor is rolled over an icon or a pixel that represent a site, the site's URL appears on the browser's URL line. In addition, information boxes deliver information about the site. If the cursor is rolled over a pixel that does not represent a site, the invention method locates the closest pixel representing a site, and the pixel that the cursor is rolled over is considered as if it was representing the site. While the cursor is rolled over the map surface, the cursor is rolled over categories. If the user delays the cursor on a category, the borders that divide this category into subcategories appear. The borders that appear are thinner than the borders of the current map level. Thus, the user obtains information on the subcategorization of the specific category the cursor is delayed on. The text that provides headlines to the subcategories, which the category is divided into, appears as well. This text appears in a smaller font that the font of this map level categorization.

While the cursor is rolled over category textual headlines, and the cursor is delayed on a headline for a selected amount of time, two arrows (one “up” and one “down”) appear at the side edges of the headline. If the user clicks the “down” arrow, an information box appears. The corner of the information box is placed over the arrow. The information box includes a textual list of the subcategories included in the chosen headline's category. If the user clicks the “up” arrow, an information box appears. The corner of the information box is placed over the arrow. The information box includes a textual list of categories that include chosen headline's category. Thus, the user obtains a list of categories starting at the upper level map and ending in the map level in which he is at present.

The user can activate the help option. When this option is activated, and the cursor is rolled over buttons, toolbars, map features, etc., text appears. This text contains help documentation.

While the cursor is rolled over the map surface, the cursor rolls over pixels and icons. If the cursor is rolled over an icon that represents a site, clicking the left mouse button causes an entry to the site's HTML content. Clicking the left button and leaving the button pressed allows the user to drag and drop the icon into another location that is not its original position. Instead of clicking the left button, if the right button is clicked, a pop up menu is opened. This menu allows the user to connect the site to a service. For example, the user can sign a site as a “mail box”. The user can also choose an option at the special toolbar that diverts the function of the mouse's left button from zooming to entry. Clicking the mouse's left button over a pixel that stands for a site while the entry option was chosen results in an entry to the site that the pixel stands for.

While the cursor is rolled over the map surface, the whole map is not visible on the screen, but only a part of it. The user may obtain a view of the hidden parts of the map by moving the cursor to the screen's edges. While the cursor is placed on the screen edge, and it is rolled in an out screen direction, the map picture shifts, and the hidden map parts are exposed. This feature is also available through the invention method special tool bar.

While the cursor is rolled over the map surface, the user may obtain a view of the hidden parts of the map by using the special intellipoint middle button on a three button mouse and the advanced “intellipoint” option. The user presses the middle button and the cursor diverts its form to the special “intellipoint” cursor. While this option is activated , the user can roll his mouse, and the map picture shifts horizontally or vertically, as a result of the cursor movement, thus revealing the hidden parts of the map. Pressing the middle button again returns the cursor to normal activation. This feature is also available through the invention method special tool bar.

All the actions described above may be activated from the keyboard, using key combinations.

It is understood that the above-described embodiment is merely illustrative of the application. Other embodiments may be readily devised by those skilled in the art which will embody the principles of the invention and fall within the spirit and scope thereof.

We claim:

1. A method of graphically presenting information regarding a computer network's categories and sites by forming a visual level model in conjunction with a network browser, comprising the steps of:
establishing a visual screen comprised of a first map level containing a plurality of main category areas, each main category area being defined by a line border, wherein each main category represents a general topic, and further comprising;
placing a text within each main category area, said text showing the general topic of the specific main category;
placing each site on said computer network within a category according to one or more general topics;
representing each site as a pixel;
placing each site's pixel on the screen within one or more main categories;
arranging a plurality of site pixels within a main category according to the similarity in site contents, wherein the distance between two individual sites is established by their degree of similarity;
providing means for accessing a site through action on said pixel;
establishing a visual screen comprised of a second map level reached by activating a zooming means on a specific first map level main category, said second map level containing a plurality of main category subcategories, each said subcategory defined by a line border, wherein each subcategory represents a subtopic of the specific main category general topic, and further comprising;
placing a text within each subcategory area, said text identifying the subtopic of the said subcategory;
categorizing each site on said computer network according to one or more said subtopics;
representing each site as a pixel;
placing each site's pixel on the screen within the areas of the subcategory according to subtopic;
arranging a plurality of site pixels within a subcategory according to the similarity in site contents, wherein the distance between two individual sites is established by their degree of similarity;
providing means for accessing a site through action on said pixel;
establishing a visual screen comprised of a third map level reached by activating a zooming means on a specific second map level subcategory, said third map level containing a plurality of subcategory subcategories, each said subcategory defined by a line border, wherein each subcategory represents a subtopic of the specific second map level subcategory, and further comprising;
placing a text within each subcategory area, said text showing identifying the subtopic of the specific subcategory;
categorizing each site on said computer network according to one or more said subcategories;
representing each site as a pixel;
placing each site's pixels on the screen within the areas of the subcategory according to subtopic;
arranging a plurality of site pixels within a subcategory according to the similarity in site contents, wherein the distance between two individual sites is established by their degree of similarity;
providing means for accessing a site through action on said pixel;
repeating the steps for establishing the third map level until there are no subcategories left and a final map is a presentation of a plurality of sites.

2. The method as recited in claim 1, further comprising the step of:
providing a grid behind each map.

3. The method as recited in claim 2, further comprising the steps of:
obtaining information from a plurality of data sources comprising data categorizing site addresses, data providing site ratings, data from sites which provide information about their own nature, and user provided data;
establishing a data base for said information;
processing said information; and
transmitting said processed information to users, said information adapted to provide said users with said maps.

4. The method as recited in claim 3, further comprising the steps of:
categorizing and rating said information in said data base;
passing the information from the data base through a category creation algorithm, wherein said algorithm takes a directory tree from the data base and creates category shapes and location;
passing the information to a sites' location algorithm wherein sites are located inside categories according to their content;
passing said information to a user data base in the user's computer, said user data base having site addresses and categories of the first and second map levels, and the other map levels that the user zooms into;
passing said information to a topographical algorithm wherein topographical features are created according to the ratings data;
presenting said information on a user's screen.

5. The method as recited in claim 4, further comprising the step of:
adding a plurality of functions to a standard browser tool bar, said functions including initialization of the said maps, determination of map level and initialization of selected services functions.

6. The method as recited in claim 5, further comprising the step of:
providing a first special toolbar illustrating a navigation path in a graphic form among map levels.

7. The method as recited in claim 6, further comprising the step of:
providing said first special toolbar with path information and history information functions comprising:
a function for shifting the screen presentation to said first level map to a home level map;
a function for scrolling said path in a lateral direction on said screen;
a function to textually represent map levels according to the main categories textually represented that the user visited before entering a current map level;
a function to enter the map level textually represented; and
a function for presenting a favorite category and site drop down menu containing all favorite sites relevant to the current map level.

8. The method as recited in claim 7, further comprising the step of:
providing a second special toolbar as a window, said window having a top section providing toolbar control, a search section below the top section, a toolbar box with function buttons below said search section, and a bottom section providing toolbar tips and online help.

9. The method as recited in claim 1, further comprising the steps of:
adding an icon with graphical information to each site; and
providing means for accessing a site through action on said icon.

10. The method as recited in claim 9, further comprising the step of:
providing a grid behind each map.

11. The method as recited in claim 10, further comprising the step of:
choosing a site which appears on the map as an icon and presenting it as an image.

12. The method as recited in claim 11, further comprising the step of:
providing a services function by a signing process wherein said signing is a visual output of a specific service within the services function, said visual output being projected onto an icon or image.

13. The method as recited in claim 12, further comprising the step of:
rendering an icon into a graphical sign of a uniform resource locator on a map.

14. The method as recited in claim 13, further comprising the step of:
identifying a site service with an icon.

15. The method as recited in claim 14, further comprising the step of:
presenting the image as a window.

16. The method as recited in claim 15, further comprising the steps of:
establishing a data base with site addresses, said sites having page data written in HyperText Markup Language (HTML);
obtaining a desired site address from said database;
connecting said window to said site address;
obtaining said site HTML page data; and
presenting said page data in said window.

17. The method as recited in claim 16, further comprising the step of:
providing data relating to a site to an information box on a map, said data having a form which may be textual, graphical or animated.

18. The method as recited in claim 17, further comprising the steps of:
obtaining information from a plurality of data sources comprising data categorizing site addresses, data providing site ratings, data from sites which provide information about their own nature, and user provided data;
establishing a data base for said information;
processing said information; and
transmitting said processed information to users, said information adapted to provide said users with said maps.

19. The method as recited in claim 18, further comprising the steps of:
categorizing and rating said information in said data base;
passing the information from the data base through a category creation algorithm, wherein said algorithm takes a directory tree from the data base and creates category shapes and location;
passing the information to a sites' location algorithm wherein sites are located inside categories according to their content;
passing said information to a services algorithm wherein sites are signed as icons at each map level;
passing said information to a user data base in the user's computer, said user data base having site addresses and categories of the first and second map levels, and the other map levels that the user zooms into;
accessing said user data base with a local services algorithm to determine which sites are signed as icons at each map level;
passing said information to a topographical algorithm wherein topographical features are created according to the ratings data;
presenting said information on a user's screen.

20. The method as recited in claim 19, further comprising the step of:
adding a plurality of functions to a standard browser tool bar, said functions including initialization of the said maps, determination of map level and initialization of selected services functions.

21. The method as recited in claim 20, further comprising the step of:
providing a first special toolbar illustrating a navigation path in a graphic form among map levels.

22. The method as recited in claim 21, further comprising the step of:
providing said first special toolbar with path information and history information functions comprising:
a function for shifting the screen presentation to said first level map to a home level map;
a function for scrolling said path in a lateral direction on said screen;
a function to textually represent map levels according to the main categories textually represented that the user visited before entering a current map level;
a function to enter the map level textually represented; and
a function for presenting a favorite category and site drop down menu containing all favorite sites relevant to the current map level.

23. The method as recited in claim 22, further comprising the step of:
providing a second special toolbar as a window, said window having a top section providing toolbar control, a search section below the top section, a toolbar box with function buttons below said search section, and a bottom section providing toolbar tips and online help.

24. The method as recited in claim 9, further comprising the steps of:
rating each of said sites according to preselected parameters;
adding topographic features to each of said map levels;
correlating each site pixel with a topographic feature; and
locating each site on a topographic feature according to the site rating.

25. The method as recited in claim 24, further comprising the step of:
providing a grid behind each map.

26. The method as recited in claim 25, further comprising the step of:
choosing a site which appears on the map as an icon and presenting it as an image.

27. The method as recited in claim 26, further comprising the step of:
providing a services function by a signing process wherein said signing is a visual output of a specific service within the services function, said visual output being projected onto an icon or image.

28. The method as recited in claim 27, further comprising the step of:
rendering an icon into a graphical sign of a uniform resource locator on a map.

29. The method as recited in claim 28, further comprising the step of:
identifying a site service with an icon.

30. The method as recited in claim 29, further comprising the step of:
presenting the image as a window.

31. The method as recited in claim 30, further comprising the steps of:
establishing a data base with site addresses, said sites having page data written in HyperText Markup Language (HTML);
obtaining a desired site address from said database;
connecting said window to said site address;
obtaining said site HTML page data; and
presenting said page data in said window.

32. The method as recited in claim 31, further comprising the step of:
providing data relating to a site to an information box on a map, said data having a form which may be textual, graphical or animated.

33. The method as recited in claim 32, further comprising the steps of:
obtaining information from a plurality of data sources comprising data categorizing site addresses, data providing site ratings, data from sites which provide information about their own nature, and user provided data;
establishing a data base for said information;
processing said information; and
transmitting said processed information to users, said information adapted to provide said users with said maps.

34. The method as recited in claim 33, further comprising the steps of:
categorizing and rating said information in said data base;
passing the information from the data base through a category creation algorithm, wherein said algorithm takes a directory tree from the data base and creates category shapes and location;
passing the information to a sites' location algorithm wherein sites are located inside categories according to their content;
passing said information to a services algorithm wherein sites are signed as icons at each map level;
passing said information to a user data base in the user's computer, said user data base having site addresses and categories of the first and second map levels, and the other map levels that the user zooms into;
accessing said user data base with a local services algorithm to determine which sites are signed as icons at each map level:
passing said information to a topographical algorithm wherein topographical features are created according to the ratings data;
presenting said information on a user's screen.

35. The method as recited in claim 34, further comprising the step of:
adding a plurality of functions to a standard browser tool bar, said functions including initialization of the said maps, determination of map level and initialization of selected services functions.

36. The method as recited in claim 35, further comprising the step of:
providing a first special toolbar illustrating a navigation path in a graphic form among map levels.

37. The method as recited in claim 36, further comprising the step of:
providing said first special toolbar with path information and history information functions comprising:
a function for shifting the screen presentation to said first level map to a home level map;
a function for scrolling said path in a lateral direction on said screen;
a function to textually represent map levels according to the main categories textually represented that the user visited before entering a current map level;
a function to enter the map level textually represented; and
a function for presenting a favorite category and site drop down menu containing all favorite sites relevant to the current map level.

38. The method as recited in claim 37, further comprising the step of:
providing a second special toolbar as a window, said window having a top section providing toolbar control, a search section below the top section, a toolbar box with function buttons below said search section, and a bottom section providing toolbar tips and online help.
